(19) United States
(12) Patent Application Publication
(10) Pub. No.: US 2005/0276173 A1
(43) Pub. Date: Dec. 15, 2005

(54) Apparatus and method for focus pull-in

(75) Inventor: Moon-soo Han, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD., Suwon-si (KR)

(21) Appl. No.: 11/142,461

(22) Filed: Jun. 2, 2005

(30) Foreign Application Priority Data
Jun. 10, 2004 (KR) 2004-42579

(51) Int. Cl. G11B 7/00

(52) U.S. Cl. 369/44.25; 369/44.27; 369/44.29

(57) ABSTRACT

An apparatus for a focus pull-in and a method thereof that can promptly stabilize a focus servo operation. The apparatus includes an optical pickup having an object lens focusing a light emitted from a light source on an optical disc, a focus actuator moving the object lens along an optical axis of the object lens, and an optical detector converting the light reflected from the optical disc into electric signals; a focus error generation unit generating a focus error signal based on the electrical signals output from the optical detector; and a focus servo control unit moving the focus actuator up and down along the optical axis a specified number of times, detecting a zero cross point of at least one focus error signal generated during the moving the focus actuator down and up, and performing a focus pull-in operation at a finally detected zero cross point among the detected zero cross points. Accordingly, a focus pull-in time point can be detected more rapidly and accurately by controlling the down/up speed of the focus actuator for a focusing control.

### CROSS-REFERENCE TO RELATED APPLICATION

This application claims benefit under 35 U.S.C. § 119 from Korean Patent Application No. 2004-42579, filed on Jun. 10, 2004, the disclosure of which is incorporated herein by reference.

### BACKGROUND OF THE INVENTION

1. Field of the Invention

The present invention relates to an apparatus and method for a focus pull-in, and more particularly to an apparatus and method for a focus pull-in that can promptly stabilize a focus servo operation.

2. Description of Related Art

An optical recording/reproducing apparatus is provided with an optical pickup for reading out information from a signal-recording surface of an optical disc or recording specified information on the optical disc. Also, the optical pickup has a light source, an object lens, an optical detector, a focus actuator and a tracking actuator.

In order to read out information from an optical disc or record information on an optical disc, a laser beam emitted from a light source of an optical pickup should accurately be focused on a signal-recording surface of the optical disc. If the laser beam is not accurately focused on the signal-recording surface of the optical disc, the information recorded on the optical disc cannot be read. For this purpose, the optical recording/reproducing apparatus is provided with a focus pull-in apparatus for controlling a focusing operation.

A conventional focus pull-in apparatus, in order to perform a focusing operation, detects a focus pull-in time point by slowly moving up an object lens of an optical pickup after moving down the object lens in a direction of an optical axis, and if the focus pull-in time point is detected, it turns on a focus servo.

In order to improve the reproduction performance of an optical disc drive, the laser beam should accurately be focused on the signal-recording surface of the optical disc, and the time required until the focus servo is turned on should be shortened as well. However, if the object lens of the optical pickup moves up slowly according to the conventional focus pull-in apparatus, the time required until the focus servo is turned on is delayed.

Conversely, if the speed of moving up the object lens after the object lens moves down becomes high, the time required until the focus servo is turned on can be shortened. In this case, however, the period of a focus error signal becomes shortened, and thus it is difficult to detect the focus pull-in time point. If the period of the focus error signal is shortened while the focus error signal is sampled and then a zero cross point is detected based on the sampled signal for the detection of the focus pull-in time point, it becomes difficult to detect an accurate zero cross point due to the limitations of a sampling frequency. In other words, since it is difficult to perform an accurate detection of the focus pull-in time point, the probability that the focus pull-in fails is heightened. Accordingly, the time required for the focus pull-in may be further delayed.

Thus, there is a need for an arrangement which addresses the above drawbacks and other problems associated with the conventional arrangement

### BRIEF SUMMARY

An aspect of the present invention provides an apparatus and method for a focus pull-in that can promptly stabilize a focus servo operation.

According to an aspect of the present invention, there is provided an apparatus for a focus pull-in, including: an optical pickup having an object lens focusing a light emitted from a light source on an optical disc, a focus actuator moving the object lens along an optical axis of the object lens, and an optical detector converting the light reflected from the optical disc into electric signals; a focus error generation unit generating a focus error signal based on the electrical signals output from the optical detector; and a focus servo control unit moving the focus actuator up and down along the optical axis a specified number of times, detecting a zero cross point of at least one focus error signal generated during the moving the focus actuator down and up, and performing a focus pull-in operation at a finally detected zero cross point among the detected zero cross points.

Here, the specified number of times is more than twice, and a speed of moving down the focus actuator is different from a speed of moving up the focus actuator.

The moving-up speed of the focus actuator finally performed may be set to a speed lower than the moving-up speed of the focus actuator first performed.

According to an aspect of the present invention, there is provided a focus pull-in method, including: moving down and up a focus actuator moving an object lens in a direction of an optical axis of the object lens at a specified speed; detecting a zero cross point of at least one focus error signal generated during the moving the focus actuator down and up a specified number of times; and performing a focus pull-in operation at the finally detected zero cross point among the detected zero cross points.

The specified number of times may be more than twice, and a speed of moving down the focus actuator may be different from a speed of moving up the focus actuator.

The moving-up speed of the focus actuator finally performed may be set to a speed lower than the moving-up speed of the focus actuator first performed.

According to another aspect of the present invention, there is provided a focus control method, including: driving a focus actuator to move an object lens in a first direction along an optical axis of the object lens to a first specified position at a first speed; driving the focus actuator to move the object lens in a second direction opposite the first direction along the optical axis until a zero cross point (ZCP) of a first focus error (FE) signal is detected; driving the focus actuator to move the object lens in the first direction at a third speed until a ZCP of a second FE signal is detected; driving the focus actuator to move the object lens in the second direction at a fourth speed until a ZCP of a third FE signal is detected; and performing a focus pull-in operation when the ZCP of the third FE signal is detected.

According to another aspect of the present invention, there is provided a method of stabilizing a focus servo operation, including: moving a focus actuator for a focusing control up and down along the optical axis multiple times; detecting a zero cross point (ZCP) of at least one focus error (FE) signal generated during the moving; and judging a finally detected zero cross point among the zero cross points of the at least one FE signal detected during the moving as a focus pull-in time point, and performing a focus pull-in operation at the finally detected zero cross point.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a block diagram schematically illustrating an apparatus for a focus pull-in according to an embodiment of the present invention;

FIG. 2 is a flowchart illustrating a method for a focusing control for the apparatus for the focus pull-in as illustrated in FIG. 1; and

FIG. 3 is a view illustrating a waveform of a focus drive signal for a focusing control.

### DETAILED DESCRIPTION OF EMBODIMENT

Reference will now be made in detail to an embodiment of the present invention, examples of which are illustrated in the accompanying drawings, wherein like reference numerals refer to the like elements throughout. The embodiment is described below in order to explain the present invention by referring to the figures.

In the following description, same drawing reference numerals are used for the same elements even in different drawings. Also, well-known functions or constructions are not described in detail.

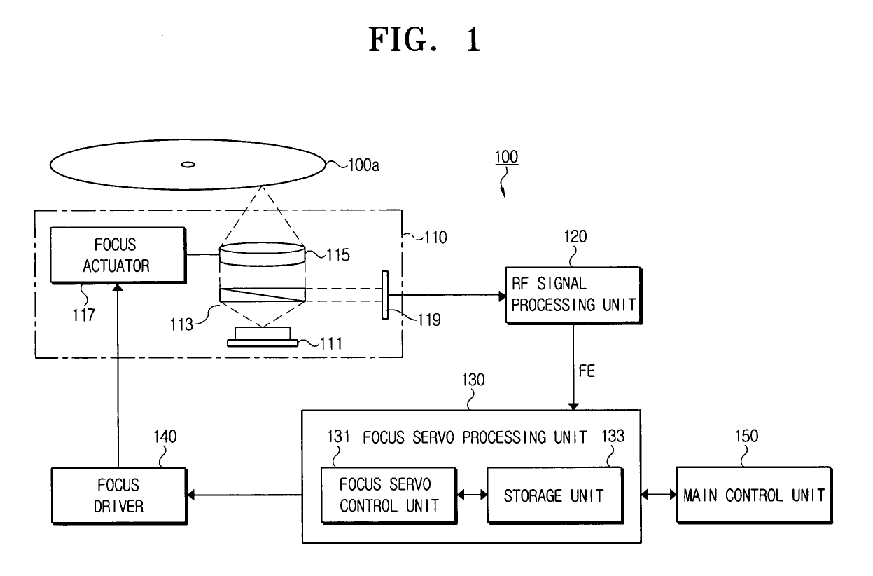

FIG. 1 is a block diagram schematically illustrating an apparatus for a focus pull-in according to an embodiment of the present invention.

Referring to FIG. 1, the apparatus 100 for a focus pull-in includes an optical pickup 110, a (Radio Frequency) (RF) signal processing unit 120, a focus servo processing unit 130, a focus driver 140, and a main control unit 150.

The apparatus 100 for a focus pull-in is an apparatus for controlling a laser beam emitted from the optical pickup 110 to accurately focus on a signal recording surface of an optical disc 100a, and is provided in an optical recording/reproducing apparatus for recording information on the optical disc 100a or reading information recorded on the optical disc 100a such as, by way of non-limiting examples, a CDP (Compact Disc Player), a DVDP (Digital Versatile Disc Player), and a PC.

The optical pickup 110 receives the laser beam reflected from the optical disc 100a, and converts the received laser beam into electric signals. For this purpose, the optical pickup 110 is provided with a light source 111, a beam splitter 113, an object lens 115, a focus actuator 117, and an optical detector 119.

The light source 111 emits laser beams of specified wavelengths. That is, the light source 111 emits laser beams of different wavelengths in accordance with the kind of the loaded optical disc 100a.

The beam splitter 113 reflects and/or transmits the laser beam emitted from the light source 111 in a specified ratio.

The object lens 115 focuses the laser beam incident from the beam splitter 113 on the signal-recording surface of the optical disc 100a.

The focus actuator 117 moves the object lens 115 along an optical axis so that the laser beam incident to the optical disc 100a is accurately focused on the signal-recording surface of the optical disc 100a. That is, the focus actuator 117 adjusts the distance between the optical disc 100a and the object lens 115 by moving the object lens 115 up and down in order to turn on the focus servo.

The optical detector 119 detects the laser beam reflected from the optical disc 100a, and converts the detected laser beam into electric signals. The signals converted by the optical detector 119 are provided to the RF signal processing unit 120.

The RF signal processing unit 120 generates a focus error (FE) signal for a focus servo using the electric signals A, B, C and D detected by the optical detector 119. The generated FE signal is provided to the focus servo processing unit 130.

The focus servo processing unit 130 performs a focusing control operation of the optical pickup 110, and is provided with a focus servo control unit 131 and a storage unit 133.

The focus servo control unit 131 generates a focus drive signal for driving the focus actuator 117 based on the FE signal provided from the RF signal processing unit 120, and outputs the focus drive signal to the focus driver 140. That is, the focus servo control unit 131 outputs to the focus driver 140 the focus drive signal for moving the focus actuator 117 down/up along the optical axis (a down/up operation).

The focus servo control unit 131 moves down/up the focus actuator 117 for a focusing control along the optical axis for a specified number of times, and detects a zero cross point of at least one FE signal generated during the down/up operation. For this purpose, the focus servo control unit 131 performs a sampling of the FE signal outputted from the RF signal processing unit 120 in response to the down/up operation of the focus actuator 117, and detects the zero cross point of the FE signal based on the sampled digital signal. Then, the focus servo control unit 131 judges the finally detected zero cross point among the zero cross points of the at least one FE signal detected during the down/up operation as a focus pull-in time point, and performs the focus pull-in operation at the finally detected zero cross point.

The focus servo control unit 131 according to the present embodiment performs the down/up operation at least twice in order to detect the focus pull-in time point, and the down/up speed of the focus actuator 117 may differently be set. However, it is to be understood that the present embodiment is not limited thereto, and the moving-up speed of the focus actuator finally performed may be set to a speed lower than the moving-up speed of the focus actuator previously performed.

The focus driver 140 provides a drive voltage, which corresponds to the focus drive signal outputted from the focus servo control unit 131, to the focus actuator 117. The focus actuator 117 moves up/down the object lens along the optical axis in proportion to the voltage supplied from the focus driver 140.

The main control unit 150 outputs control signals for controlling the focusing operation of the optical pickup 110, and controls the whole operation of the focus pull-in apparatus 100.

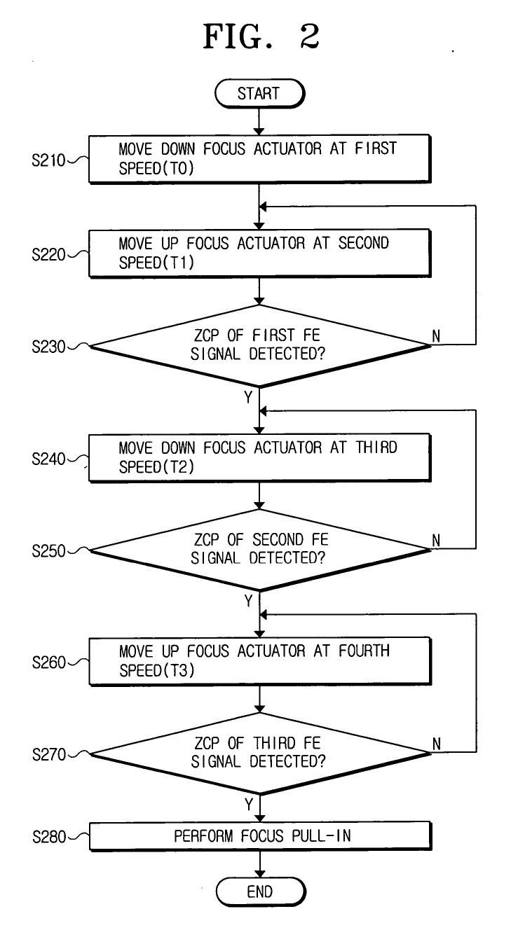

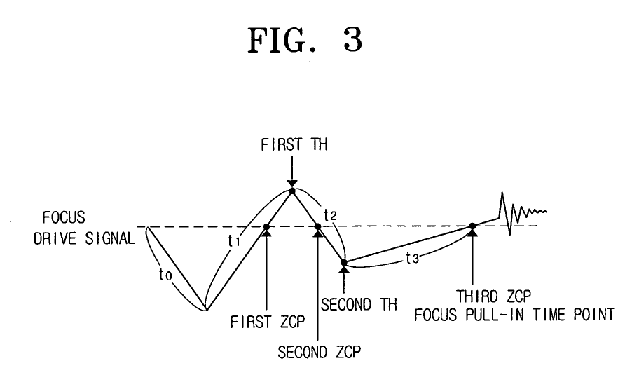

Hereinafter, a method for a focus pull-in according to an embodiment of the present invention will be explained with reference to FIGS. 2 and 3.

FIG. 2 is a flowchart illustrating the method for a focusing control, and FIG. 3 is a view illustrating a waveform of a focus drive signal for a focusing control. The method of FIG. 2 is performable by the apparatus for the focus pull-in of FIG. 1 and is, for ease of explanation, described with concurrent reference to that figure. However, it is to be understood that the method can be performed by other apparatuses.

In the present embodiment, the down/up operation of the focus actuator 117 is performed twice for the focusing control. However, it is to be understood that the number of times the down/up operation is performed is not limited to two.

Referring to FIGS. 1 to 3, the focus servo control unit 131 provides the focus drive signal of a first speed t₀ to the focus driver 140 in order to move the focus actuator 117 down to a specified position (operation S210). The focus actuator 117 moves the object lens 115 down to the specified position in accordance with the focus drive signal of the first speed t₀ applied from the focus driver 140.

If the focus actuator 117 moves down to the specified position, the focus servo control unit 131 provides the focus drive signal of a second speed t₁, which is for moving the focus actuator 117 up, to the focus driver 140 until the zero cross point (i.e., first ZCP) of the first FE signal is detected (operation S220). The focus actuator 117 moves the object lens 115 up to the position that corresponds to the focus drive signal of the second speed t₀ provided from the focus driver 140.

If the zero cross point (i.e., first ZCP) of the first FE signal is detected while the focus actuator 117 moves up (operation S230), the focus servo control unit 131 moves the focus actuator 117 up to a first threshold value (i.e., first TH). This moving-up operation of the focus actuator 117 is continuously performed until the zero cross point (i.e., first ZCP) of the first FE signal is detected.

If the focus actuator 117 moves up to the first threshold value (i.e., first TH), the focus servo control unit 131 provides the focus drive signal of a third speed t₂, which is for moving the focus actuator 117 down, to the focus driver 140 until the zero cross point (i.e., second ZCP) of the second FE signal is detected (operation S240). The focus actuator 117 moves the object lens 115 down to the position that corresponds to the focus drive signal of the third speed t₂ provided from the focus driver 140.

If the zero cross point (i.e., second ZCP) of the second FE signal is detected while the focus actuator 117 moves down (operation S250), the focus servo control unit 131 provides the focus drive signal for moving the focus actuator 117 down to the second threshold value (i.e., second TH) to the focus driver 140. Here, the moving-down operation of the focus actuator 117 is continuously performed until the zero cross point of the second FE signal is detected.

If the focus actuator 117 moves down to the second threshold value (i.e., second TH), the focus servo control unit 131 provides the focus drive signal of a fourth speed t₃, which is for moving the focus actuator 117 up, to the focus driver 140 until the zero cross point (i.e., third ZCP) of the third FE signal is detected (operation S260). The focus actuator 117 moves the object lens 115 up to the position that corresponds to the focus drive signal of the fourth speed t₃ provided from the focus driver 140.

If the zero cross point (i.e., third ZCP) of the third FE signal is detected while the focus actuator 117 moves up (operation S270), the focus servo control unit 131 performs the focus pull-in operation at a time point that the zero cross point (i.e., third ZCP) of the third FE signal is detected (operation S280). If the focus pull-in succeeds, the focus servo is turned on, and this causes a focus servo loop for controlling the focusing of the optical pickup 110 to be formed based on the FE signal outputted from the RF signal processing unit 120.

The first speed t₀ to the third speed t₂ may be the same or different from one another. However, it can be preferable to set the fourth speed t₃ to a speed lower than the first speed t₀ to the third speed t₂, and to set the first speed t₀ to the third speed t₂ to a speed higher than the up/down speed of the conventional focus actuator 117. Also, information about the first speed t₀ to the fourth speed t₃ and information about the first threshold value (i.e., first TH) and the second threshold value (i.e., second TH) are stored in the storage unit 133 of the focus servo processing unit 130, and are provided from the main control unit 150.

The fact that the fourth speed t₃ is lower than the first speed t₀ to the third speed t₂ means that the period of the third FE signal generated in a section of the fourth speed t₃ is larger than the period of the first FE signal and the second FE signal generated in a section of the first speed t₀ to the third speed t₂. Accordingly, the third FE signal can be sampled more minutely than the first FE signal and the second FE signal.

Consequently, the focusing control signal for turning on the focus servo can be reduced, and the focus pull-in time point can be detected more accurately in comparison to the conventional focus pull-in apparatus.

According to the above-described embodiment of the apparatus and method for a focus pull-in, the focus pull-in time point can be detected more rapidly and accurately by controlling the down/up speed of the focus actuator for a focusing control. Accordingly, the focus servo operation can be stabilized promptly, and thus the reproduction performance of the optical recording/reproducing apparatus can be improved.

Although an embodiment of the present invention have been shown and described, the present invention is not limited to the described embodiment. Instead, it would be appreciated by those skilled in the art that changes may be made to the embodiment without departing from the principles and spirit of the invention, the scope of which is defined by the claims and their equivalents.

1. An apparatus for a focus pull-in, comprising:
an optical pickup having an object lens focusing a light emitted from a light source on an optical disc, a focus actuator moving the object lens along an optical axis of the object lens, and an optical detector converting the light reflected from the optical disc into electric signals;
a focus error generation unit generating a focus error signal based on the electrical signals output from the optical detector; and
a focus servo control unit moving the focus actuator up and down along the optical axis a specified number of times, detecting a zero cross point of at least one focus error signal generated during the moving the focus actuator down and up, and performing a focus pull-in operation at a finally detected zero cross point among the detected zero cross points.

2. The apparatus as claimed in claim 1, wherein the specified number of times is at least three.

3. The apparatus as claimed in claim 1, wherein a speed of moving the focus actuator down is different from a speed of moving the focus actuator up.

4. The apparatus as claimed in claim 1, wherein the moving-up speed of the focus actuator finally performed is set to a speed lower than the moving-up speed of the focus actuator first performed.

5. A method for a focus pull-in, comprising:
moving down and up a focus actuator moving an object lens in a direction of an optical axis of the object lens at a specified speed;
detecting a zero cross point of at least one focus error signal generated during the moving the focus actuator down and up a specified number of times; and
performing a focus pull-in operation at the finally detected zero cross point among the detected zero cross points.

6. The method as claimed in claim 5, wherein the specified number of times is at least three.

7. The method as claimed in claim 5, wherein a speed of moving the focus actuator down is different from a speed of moving the focus actuator up.

8. The method as claimed in claim 6, wherein the moving-up speed of the focus actuator finally performed is set to a speed lower than the moving-up speed of the focus actuator first performed.

9. A focus control method, comprising:
driving a focus actuator to move an object lens in a first direction along an optical axis of the object lens to a first specified position at a first speed;
driving the focus actuator to move the object lens in a second direction opposite the first direction along the optical axis until a zero cross point (ZCP) of a first focus error (FE) signal is detected;
driving the focus actuator to move the object lens in the first direction at a third speed until a ZCP of a second FE signal is detected;
driving the focus actuator to move the object lens in the second direction at a fourth speed until a ZCP of a third FE signal is detected; and
performing a focus pull-in operation when the ZCP of the third FE signal is detected.

10. The method as claimed in claim 9, wherein the first, second and third speeds differ.

11. The method as claimed in claim 9, wherein the fourth speed is less than the first, second and third speeds.

12. A method of stabilizing a focus servo operation, comprising:
moving a focus actuator for a focusing control up and down along the optical axis multiple times;
detecting a zero cross point (ZCP) of at least one focus error (FE) signal generated during the moving; and
judging a finally detected zero cross point among the zero cross points of the at least one FE signal detected during the moving as a focus pull-in time point, and performing a focus pull-in operation at the finally detected zero cross point.
